(19) United States
(12) Patent Application Publication
(10) Pub. No.: US 2003/0122428 A1
(43) Pub. Date: Jul. 3, 2003

(54) Security system

(76) Inventor: Jeremy Christopher Rice-McDonald, Perthshire (GB)

Correspondence Address: Oliff & Berridge, PO Box 19928, Alexandria, VA, 22320, US

(21) Appl. No.: 10/257,007

(22) PCT Filed: Apr. 12, 2001
(86) PCT No.: PCT/GB01/01706

(30) Foreign Application Priority Data
Apr. 14, 2000 (GB) 0009309.6

(51) Int. Cl. H01H 27/00

(52) U.S. Cl. 307/10.3

(57) ABSTRACT

A locking mechanism for locking and/or unlocking a door, window or the like comprises a barrel having a number of apertures, each aperture being connected to a light emitter or a light sensor via an optic fibre. A key for insertion into the barrel is also provided with a number of apertures internally connected via optic fibres for optically connecting selected ones of the apertures in the barrel together. When the key is in place, continuous light paths are provided between the light emitters and the light sensors, the latter being arranged to actuate the locking mechanism.

The present invention relates to a security system and particularly, but not exclusively, to an optoelectronic “lock and key” system.

Known security systems which are used for locking, for example, doors or windows include conventional mechanical lock and key systems, punched “Ving” cards, combination locks and so-called “keyless entry” locks involving electronic numeric keypads. More recent systems involve electronic “smart” cards which are swiped across a scanner, remote key mechanisms which use coded electromagnetic waves to remotely operate the lock and high-tech fingerprint or retinal scanners. Such systems are generally subject to a number of disadvantages these being, for example, that they are easy to circumvent by picking or grabbing, that they are easy to copy or require the memorising of a number by the user or that they are expensive.

The present invention aims to provide an improved security system.

According to one aspect of the present invention there is provided a locking mechanism for locking and/or unlocking a door, window or the like, the mechanism comprising:

a key, transmission means for generating and transmitting a signal, first conductor means for conducting the signal from the transmission means, receiver means for receiving the signal and second conductor means for conducting the signal to the receiver means;

characterised in that the key is arranged to be positioned between the first and second conductor means, the key having connecting means for connecting together the first and second conductor means thereby to allow the signal to be passed from the transmission means to the receiver means, wherein the receiver means is operable to actuate the locking mechanism.

Preferably, the locking mechanism also includes a barrel, wherein the first conductor means is arranged to conduct the signal between the transmission means and the barrel and the second conductor means is arranged to conduct the signal between the barrel and the receiver means, and wherein the barrel is arranged for insertion of the key therein, thereby to connect the first and second conductor means.

The transmission means may include encoder means for encoding the signal before its transmission. The receiver means may therefore include decoder means for decoding the signal after its reception.

Advantageously, the signal may be an electromagnetic signal. Preferably, the first and second conductor means and the connecting means comprises optic fibres and the electromagnetic signal is in the form of a light signal.

The present invention will now be described, by way of example only, with reference to the accompanying drawings in which:

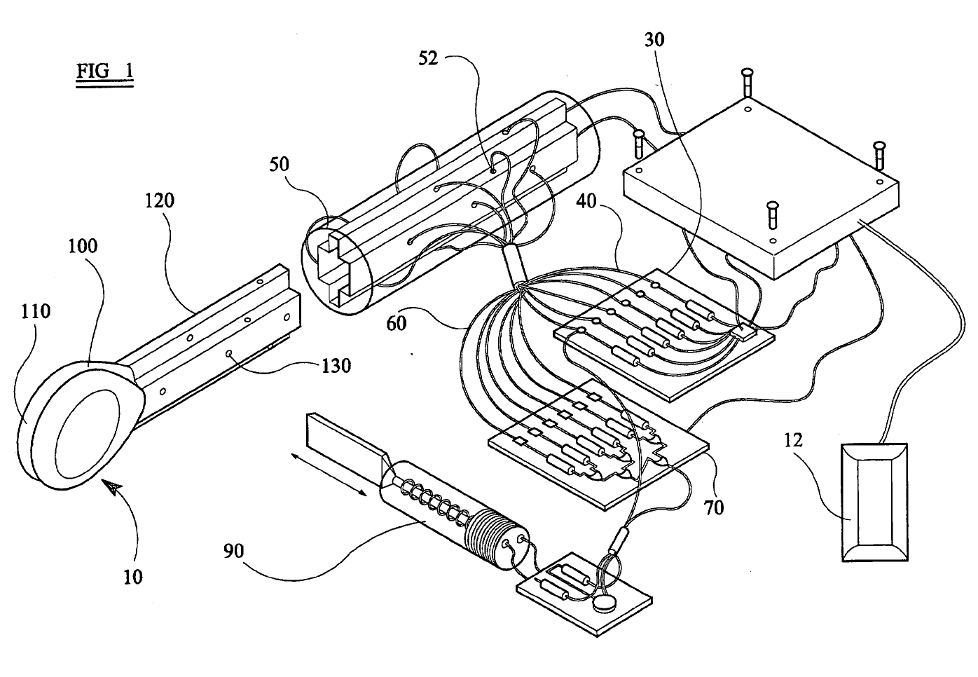

FIG. 1 shows a preferred form of locking mechanism according to the invention;

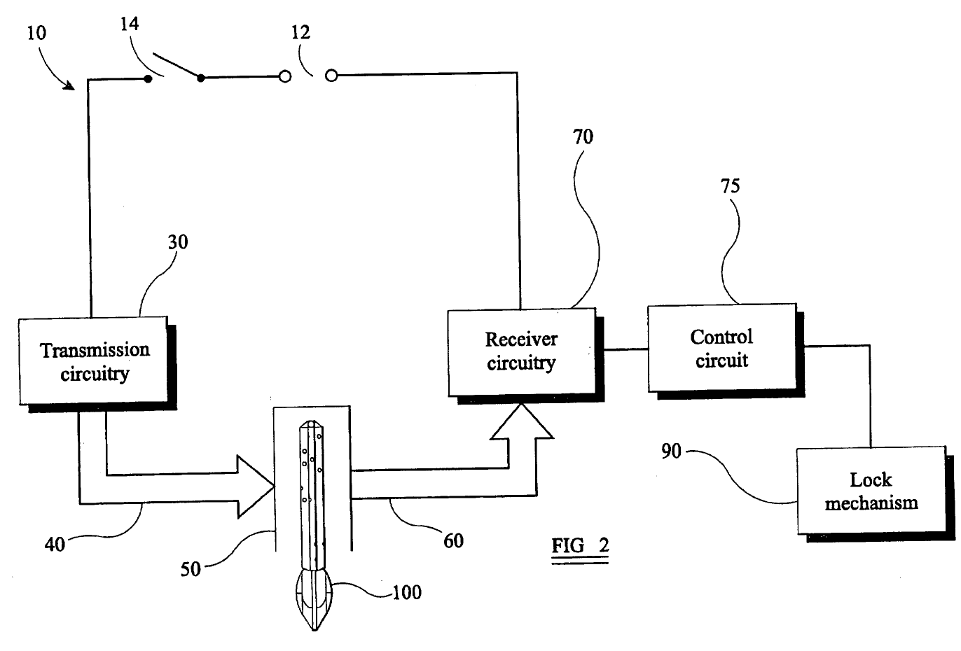

FIG. 2 is a schematic block diagram of the locking mechanism of FIG. 1;

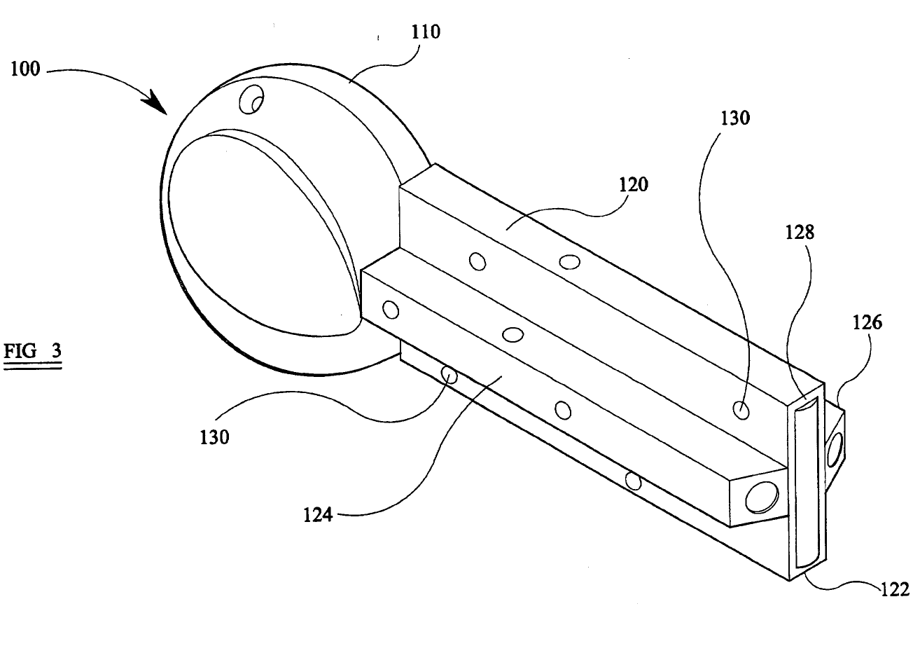

FIG. 3 is a perspective view of a preferred form of key for use with the locking mechanism of FIG. 1;

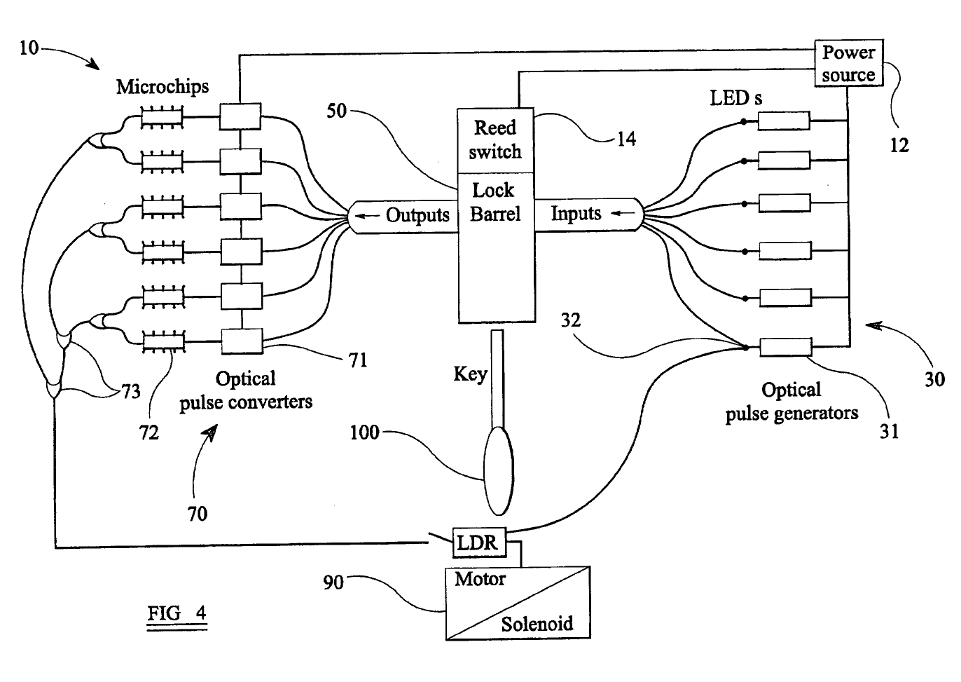

FIG. 4 shows an alternative form of locking mechanism according to the invention;

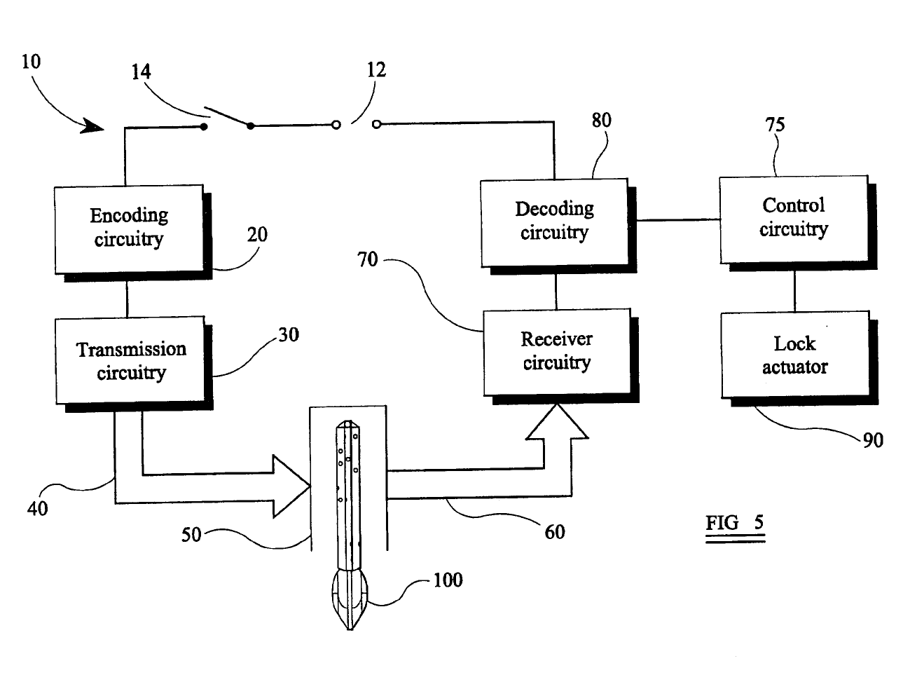

FIG. 5 is a schematic block diagram of the locking mechanism of FIG. 4; and

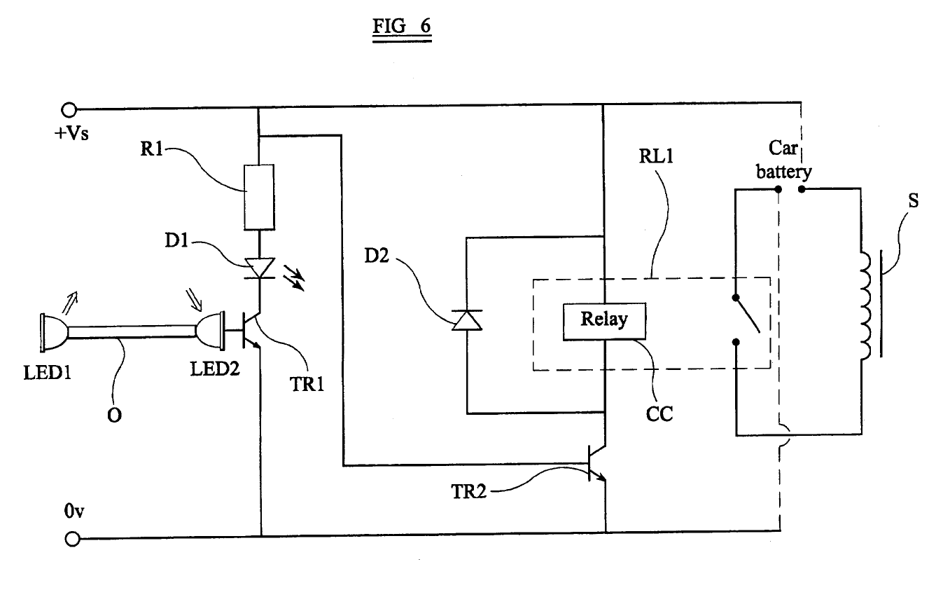

FIG. 6 shows an anti-tampering circuit for use with the locking mechanism of FIG. 1.

Referring to FIGS. 1 to 3, a preferred form of locking mechanism is shown generally at 10. In this embodiment, the locking mechanism is intended for locking and unlocking the doors of vehicles such as cars, vans or the like. It will be appreciated, however, that this is merely an example of one possible application for the locking mechanism.

The locking mechanism 10 comprises a power supply 12 which, in this case, is a 12 volt supply provided by the vehicle battery in a manner similar to that used in conventional vehicle central locking systems.

The locking mechanism 10 has a barrel 50 which, in this embodiment, is generally cylindrical in external shape so as to fit in the apertures provided in the vehicle door. Associated with the barrel 50 is a key 100, a preferred form of which is shown in FIG. 3. In this embodiment, the key has a handle portion 110 and a shank portion 120. The shank portion 120 comprises four parallel arms 122, 124, 126, 128 which are joined together and arranged such that the cross-section of the shank is substantially cross shaped along its length.

Disposed along the parallel faces of the arms are a plurality of apertures 130. Each of the apertures 130 is connected internally within the shank of the key 100 to another aperture by means of an optic fibre link, the purpose of which is described below. Importantly, the use of relatively flexible optical fibres means that there need be no positional relationship between the linked apertures 130. Thus a given aperture 130 can be linked to any other aperture on the key.

The internal cross section of the barrel 50 is shaped to correspond to the cross section of the shank 120 of the key 100. Thus, the internal shape of the barrel 50 consists of four channels running parallel to each other along the length of the barrel, each channel being designed to receive one of the arms of the key 100. A plurality of apertures 52 are disposed along the faces of the channels in the barrel and correspond in number and position to the apertures 130 disposed on the shank of the key.

Each of the apertures in the channels of the barrel is connected either to a transmission circuit 30 or to a receiver circuit 70 by means of an optic fibre link 40, 60. The transmission circuit 30 includes a plurality of light sources, such as LED's or the like, and is operable to activate the light sources to generate a plurality of light signals, each of which is transmitted along a respective optic fibre link 40 to one of the apertures in the barrel.

The receiver circuit 70 includes a plurality of sensors operable to detect light signals. The sensors are arranged to receive light signals transmitted along the optic fibre link 60 from the apertures 52 in the barrel 50.

The receiver circuit 70 is connected to a control circuit 75 which is additionally connected to the lock actuator 90 of the vehicle door.

The locking mechanism 10 further includes a switch 14 which is selectively operable to connect the locking mechanism to the power supply 12. Although in FIG. 2, the switch 14 is shown as an independent element, in practice the switch is preferably located within the barrel 50 as shown in FIG. 4 and is arranged such that the switch is closed only when the key 100 is fully inserted in the barrel 50. In this regard, the shank of the key 100 may be made of a conducting material so that insertion of the key in the barrel makes a contact between two electrodes of the switch thereby completing a circuit and providing electrical power to the locking mechanism.

Operation of the locking mechanism 10 of FIGS. 1-3 is now described. Firstly, a user inserts the key 100 fully into the barrel 50. This action actuates the switch 14 which completes the electrical circuit and allows electrical current to flow from the battery 12 to the transmission circuitry 30 and the receiver circuitry 70.

The transmission circuitry 30 generates light signals from the LED's which are transmitted along the optic fibres 40 to the apertures 52 in the barrel 50. If the correct key is inserted in the barrel, the apertures 130 in the shank of the key and those in the barrel are exactly aligned such that a continuous transmission path is provided from the transmission circuitry 30, through the key 100, to the receiver circuitry 70.

The light signals are thus transmitted along the optic fibre link in the shank of the key and then along the optic fibre link 60 to the receiver circuitry 70. When the sensors in the receiver circuitry receive the light signals generated by the transmission circuitry, the receiver circuitry sends a control signal to the control circuitry 75 which actuates the lock actuator thereby to lock or unlock the vehicle door.

It will be appreciated that only a key having apertures which align substantially with the apertures in the barrel can be used to actuate the lock mechanism. Thus, the locking mechanism of the present invention provides a unique “combination” wherein only one key having a specific arrangement of apertures is correctly able to “fit” the lock. The lack of mechanical and moving parts means that the locking mechanism of the present invention is extremely difficult to pick.

Various modifications and improvements may be made to the invention. For example, as shown in FIGS. 4 and 5, the locking mechanism may additionally include encoding circuitry 20 and decoding circuitry 80. The encoding circuitry 20 comprises a plurality of pulse generators or the like 31 which generate a coded series of pulses and apply the pulses to the LEDs 32 in the transmission circuitry 30. The light signals generated by the LEDs are thus encoded into a series of pulses which are transmitted along the optical fibre links.

The sensors 71 of the receiver circuitry 70 detect the light signal pulses and convert them into electrical signals which are sent to the decoding circuitry 80. The decoding circuitry comprises a number of microchips 72 which check that the coded signals are correct via logic gates 73.

When all of the signal codes are correct, the decoding circuitry sends a signal to the control circuitry 75 which actuates the lock actuator 90 thereby to lock or unlock the vehicle door.

A particular advantage provided by the present invention is that the number of possible combinations provided by the locking mechanism for a given number of LED's/sensors is considerably larger than that provided by prior art locking mechanisms. This is achieved firstly by allowing the possibility of any LED 32 in the transmission circuitry 30 being connected to any sensor 71 in the receiver circuitry 70 and secondly by encoding the light signals, transmitted by the LED's. A further increase in the number of combinations can be achieved by varying the position of the apertures 130 on the key and the corresponding apertures 52 in the barrel 50, providing even greater security.

It has been calculated by the applicant that for a locking mechanism according to the invention having 20 LEDs and 20 sensors, each LED/sensor being arranged to transmit/receive a uniquely encoded signal, there could be more than 6×10¹⁹ different combinations possible.

Advantageously, a helical groove or channel, for example in the form of a Whitworth screw thread, could be machined around the barrel to facilitate the entry and exit of the optical fibres.

In addition, the connecting cable between the control circuitry 75 and the lock actuator 90 may include an optic fibre along which a continuous light signal is transmitted. The lock actuator may be modified such that it will only operate if it is receiving the continuous light signal. If the cable is cut in an attempt to bypass the lock mechanism and power the lock actuator directly from the battery, the light connection will be broken and the lock actuator will not operate.

FIG. 6 shows a preferred form of circuit to achieve this.

In FIG. 6, a positive supply Vₛ, for example from the positive terminal of the vehicle battery, is connected to one electrode of a resistor R1. The other electrode of resistor R1 is connected to the anode of an LED D1, the cathode of which is connected to the collector of a transistor TR1. The emitter of transistor TR1 is connected to the zero volt line of the power supply, for example the negative terminal of the vehicle battery.

The positive Vₛ is connected to the collector of a second transistor TR2 via the coil CC of a relay RL1. The emitter of transistor TR2 is connected to the zero volt line. The relay RL1 is arranged such that when current passes through the coil CC, the relay contacts operate to close a circuit containing a solenoid S for operating the vehicle door locks, thereby to lock the vehicle doors. A diode D2 is reverse biased across the coil CC of the relay to protect the transistor TR2 from any back EMF generated by the relay coil.

The base of transistor TR2 is connected to the first electrode of resistor R1 whilst the base of transistor TR1 is connected to the output of a photosensor, such as a light dependent resistor LDR1. LDR1 is arranged to receive a continuous light signal from light emitting diode LED1 via an optic fibre OF1.

While the photosensor LDR1 is receiving the light signal from the LED1 via the optic fibre OF1, its output is high and transistor TR1 is switched on. Current is therefore conducted through R1, D1 and TR1 and D1 is lit to indicate correct operation. However, if the optic fibre OF1 is cut in an attempt to bypass the lock mechanism, the output of LDR1 will go low and the transistor TR1 will turn off. Current will no longer flow through R1 and D1 and thus the input to the base of transistor TR2 will go high, turning transistor TR2 on. When transistor TR2 switches on, the relay RL1 is energised, the contacts of the relay close and the solenoid S is switched on, thereby activating the vehicle door locks.

A further tamper proof measure involves the inclusion of a time delay circuit to prevent a would-be thief from making numerous attempts at unlocking the vehicle. If an incorrect key is inserted into the barrel, the time delay circuit prevents a further attempt at unlocking the vehicle for a predetermined period of time thereafter. This period of time can be increased following each failed attempt at unlocking the vehicle.

Since the lock mechanism requires only a small amount of electrical power to operate, it can be powered from any convenient source, for example a telephone line, a car battery, stepped down mains power or even a small dynamo in the hinges of the door itself.

Although the embodiment describes the use of light on the signal, other electromagnetic signal types may be used such as ultraviolet radiation, infrared radiation or the like. Alternatively electrical signals could be used. In these cases, it may be necessary to replace the optic fibres with more appropriate forms of signal conductors. In particular, it will be appreciated by those skilled in the art that photonic crystals could be used in place of optical fibres.

1. A locking mechanism for locking and/or unlocking a door, window or the like, the mechanism comprising:
a key;
transmission means for generating and transmitting a signal;
first conductor means for conducting the signal from the transmission means;
receiver means for receiving the signal; and
second conductor means for conducting the signal to the receiver means;
characterised in that the key is arranged to be positioned between the first and second conductor means, the key having connecting means for connecting together the first and second conductor means thereby to allow the signal to be passed from the transmission means to the receiver means, wherein the receiver means is operable to actuate the locking mechanism.

2. A locking mechanism as claimed in claim 1 further comprising a barrel, wherein the first conductor means is arranged to conduct the signal between the transmission means and the barrel and the second conductor means is arranged to conduct the signal between the barrel and the receiver means, and wherein the barrel is arranged for insertion of the key therein, thereby to connect the first and second conductor means.

3 A locking mechanism as claimed in claim 1 or claim 2 wherein the signal comprises an electrical signal and wherein the connecting means and each of the first and second conductor means comprises at least one electrical conductor.

4 A locking mechanism as claimed in claim 3 wherein the connecting means and each of the first and second conductor means comprises a plurality of electrical conductors.

5. A locking mechanism as claimed in claim 1 or claim 2 wherein the signal is an electromagnetic signal and wherein the connecting means and each of the first and second conductor means comprises at least one electromagnetic conductor.

6. A locking mechanism as claimed in claim 5 wherein said signal comprises a visible wavelength electromagnetic signal and wherein the connecting means and each of the first and second conductor means comprises at least one optical fibre.

7. A locking mechanism as claimed in any preceding claim wherein the transmission means includes encoder means for encoding the signal before it is transmitted.

8. A locking mechanism as claimed in claim 7 wherein the receiver means includes decoder means for decoding the signal after it is received.

9. A locking mechanism as claimed in any preceding claim further comprising switch means, the switch means being selectively operable to connect the locking mechanism to a power supply.

10. A locking mechanism as claimed in claim 9 when appendant to claim 2 wherein said switch means is located within the barrel, the switch means being actuable upon the insertion of the key into the barrel thereby to supply power to the locking mechanism.

11. A locking mechanism as claimed in any preceding claim wherein the transmission means comprises a plurality of LEDs.
